(19) United States
(12) Patent Application Publication
(10) Pub. No.: US 2025/0215271 A1
(43) Pub. Date: Jul. 3, 2025

(54) Cyanoacrylate compositions

(71) Applicant: Henkel AG & Co. KGaA, Duesseldorf (DE)

(72) Inventors: Gavin Haberlin, Naas (IE); Michael Doherty, Clane (IE); Rory Barnes, Dublin (IE); Ciara Goff, Wexford (IE); David Condron, Dublin (IE); Nigel Sweeney, Dublin (IE); Barry Burns, Dublin (IE)

(21) Appl. No.: 19/082,068

(22) Filed: Mar. 17, 2025

Related U.S. Application Data
(63) Continuation of application No. PCT/EP2023/071602, filed on Aug. 3, 2023.

(30) Foreign Application Priority Data
Sep. 15, 2022 (GB) 2213574.3

(51) Int. Cl. C09J 7/30; C09J 11/04

(52) U.S. Cl. CPC C09J 7/30; C09J 11/04; C09J 2301/408; C09J 2301/414

(57) ABSTRACT

The present invention relates to curable cyanoacrylate compositions that are suitable for use as adhesive compositions, such as for example in a tape form.

### BACKGROUND

### Field

The present invention relates to curable cyanoacrylate compositions that are suitable for use as adhesive compositions, such as for example in a tape form.

### Brief Description of Related Technology

Cyanoacrylate monomers that are solid at room-temperature are known, such as phenylethyl cyanoacrylate, ethylhexyl cyanoacrylate, and hexadecyl cyanoacrylate. Such room-temperature solid cyanoacrylate monomers can be used to prepare stick form and tape-form cyanoacrylate products. However compositions based on these monomers perform poorly relative to compositions comprising conventional room temperature liquid-form cyanoacrylate monomers, over a range of metrics. Furthermore, solid cyanoacrylate monomers are typically non-standard specialty chemicals that are costly and difficult to synthesise.

Cyanoacrylate tapes previously developed by Henkel have been based on monomers that are solid at room temperature, such as phenylethyl cyanoacrylate. However, the use of solid cyanoacrylate monomers to produce an adhesive tape prohibits their use as “instant tack” tapes and negates the primary advantage of using cyanoacrylates as instant adhesives.

Liquid cyanoacrylate monomers allow for better diffusion through the bulk, giving faster room temperature cure than solid cyanoacrylate monomers.

However, tapes based on standard liquid cyanoacrylate monomers are difficult to achieve. This is not only due to the inherent reactivity of the cyanoacrylate monomers towards film formers themselves, but also because materials with sufficient structural integrity are required to achieve adequate film formation.

A rare example of one is described in US Patent Application No. 2015/0107761, which discloses a tape comprising a curable film on a release substrate and/or carrier substrate. The curable film comprises at least one cyanoacrylate monomer and at least one film forming (co)polymer.

It would be advantageous to develop an adhesive tape which achieves instant tack without the need for heating under pressure.

### SUMMARY OF THE INVENTION

In one aspect, the present invention comprises a curable composition comprising:

a cyanoacrylate component; and
a solid thermoplastic polyether polyurethane resin; and
   wherein the solid thermoplastic polyether polyurethane resin has a molecular weight Mw in the range of from about 180,000 g/mol to about 260,000 g/mol, wherein the molecular weight Mw is as determined in accordance with ASTM D5296-05.

The compositions of the invention are non-flowable at room temperature (25° C.) and are suitable for use as adhesive compositions. Desirably, the compositions of the invention are substantially solid and may be used to provide any suitable solid form. The compositions of the invention may be used in any suitable application, for example in a tape form. The compositions of the invention may be provided on a carrier or may be in a self-supporting form. For example, the compositions can be applied onto a release liner; an interliner layer or a liner with differential release values may be used. The compositions can be applied by using a suitable solvent, for example cast from a suitable solvent onto the liner.

The solid thermoplastic polyether polyurethane resin may have a molecular weight Mw in the range of from about 200,000 g/mol to about 240,000 g/mol, such as about 215,000 g/mol to 230,000 g/mol for example 220,000 g/mol to 225,000 g/mol for example about 223,000 g/mol, wherein the molecular weight Mw is as determined in accordance with ASTM D5296-05 (Standard Test Method for Molecular Weight Averages and Molecular Weight Distribution of Polystyrene by High Performance Size-Exclusion Chromatography).

The solid thermoplastic polyether polyurethane resin may have a melting point in the range of from 160° C. to 200° C., such as from 165° C. to 190° C., for example from 170° C. to 180° C.

Suitably, the cyanoacrylate component is a liquid curable cyanoacrylate component.

The cyanoacrylate component (i) may be selected from the group comprising ethyl cyanoacrylate, butyl cyanoacrylate, β-methoxy cyanoacrylate and combinations thereof.

The solid thermoplastic polyether polyurethane resin may be present in an amount of from about 25 wt % to about 90 wt %, based on the total weight of the composition, suitably in an amount greater than 50 wt %, such as from about 65 wt % to about 85 wt %, based on the total weight of the curable composition.

Without wishing to be bound by theory, compositions comprising less than about 25 wt % of the solid thermoplastic polyether polyurethane component may have insufficient elastomeric properties to allow the composition to be adequately applied to a part to be bonded. Compositions comprising greater than about 90 wt % of the solid thermoplastic polyether polyurethane component may exhibit poor adhesive properties. When the solid thermoplastic polyether polyurethane resin is present in an amount of from about 25 wt % to about 90 wt %, based on the total weight of the curable composition this may provide the composition with an acceptable balance between adhesive performance and a composition that can form a coating with sufficient elastomeric properties to allow application of the composition to a part to be bonded.

The cyanoacrylate component (i) may be present in the curable composition in an amount from about 10 wt % to about 75 wt %, suitably in an amount of from about 10 wt % to 50 wt % for example from about 15 wt % to about 35 wt %, wherein the weight percentage is based on the total weight of the composition.

The invention may comprise a stabiliser of the cyanoacrylate component.

In some embodiments, a stabiliser of the cyanoacrylate component is present in an amount of from about 10 ppm to about 200 ppm, for example from about 25 ppm to about 100 ppm.

The stabiliser may be selected from boron trifluoride (BF₃) or sulfur dioxide (SO₂).

Desirably, the stabiliser is sulfur dioxide (SO₂).

The composition of the invention may further comprise at least one solvent. The use of a solvent may be beneficial, for example, for formulation or dispensing purposes.

However, wherever weight percentages are used, they are based on the total weight of the composition without solvent.

In some embodiments, the invention comprises a solvent selected from the group comprising ethyl acetate, tetrahydrofuran, methyl ethyl ketone, cyclohexanone, and acetone.

Desirably, the invention comprises ethyl acetate as a solvent.

Compositions of the invention may be provided in any suitable solid form, such as in tape form, filament form or as a coating applied to a substrate.

Suitably, a composition of the invention is provided in tape form.

In another aspect, the invention also relates to a tape comprising a curable composition according to the invention and one or more release liners.

A tape of the present invention may be a transfer tape. The release liner(s) may be used to transfer the curable composition, for example in film form, to at least one substrate.

Tapes of the present invention may exhibit adhesion properties at room temperature, wherein the curable composition of the article may be attached to at least one surface through the application of mild pressure to the tape. The cyanoacrylate component of the composition will act as an instant adhesive. Accordingly, the composition of the invention should instantly bond to any compatible substrate.

In another aspect, the invention also relates to a method of preparing a curable composition comprising the steps of:
(i) combining a solid thermoplastic polyether polyurethane resin component as set out above with a cyanoacrylate component as set above and a solvent to form a mixture;
(ii) applying the mixture of step (i) to a substrate, optionally by casting;
(iii) allowing the solvent to evaporate or actively removing the solvent, thereby forming a solid form curable composition.

In some embodiments of the method, the substrate is a release liner.

In some embodiments of the method, the solvent is ethyl acetate.

In some embodiments of the method, the solid thermoplastic polyether polyurethane resin is present in the curable composition in an amount of greater than about 50 wt %, wherein the weight percentage is based on the total weight of the composition.

The solid thermoplastic polyether polyurethane resin may be present in amount equal to or higher than that of the cyanoacrylate component.

In another aspect, the invention also relates to a cured form of the composition according to the invention.

In yet another aspect, the invention further relates to an assembly comprising two substrates bonded together by the cured form of the composition of the invention.

### DETAILED DESCRIPTION

As outlined above, the present invention provides a curable composition comprising: a cyanoacrylate component and a solid thermoplastic polyether polyurethane resin; wherein the solid thermoplastic polyether polyurethane resin has a molecular weight Mw in the range of from about 180,000 g/mol to about 260,000 g/mol, wherein the molecular weight Mw is as determined in accordance with ASTM D5296-05.

It has been surprisingly found that combining a solid thermoplastic polyether polyurethane resin with a curable cyanoacrylate component can be used to produce films with very high integrity.

The solid thermoplastic polyether polyurethane resins used in the curable compositions of the present invention may be present in an amount of greater than about 50 wt % based on the total weight of the composition. Without wishing to be bound by any theorem, it is believed that this relatively high proportion of thermoplastic polyether polyurethane resin in the composition may contribute to the high integrity of any film formed by the composition.

Thermoplastic polyether polyurethane resins have shown excellent stability in various types of cyanoacrylate monomers.

Thermoplastic polyether polyurethane resins have mechanical properties ranging between those of thermoplastic and thermoset materials. This is achieved by ‘virtual crosslinks’ caused by the H-bonding effect between urethane groups on opposite polymeric chains. This inter-chain H-bonding imparts various physical attributes to these unusual materials and manifests itself macroscopically in the form of excellent elasticity and elongation.

These rubbery or elastic-type properties make it possible to produce films of very high integrity.

Furthermore, thermoplastic polyether polyurethane resin film formers have excellent tensile strength and elongation properties which offer benefits over other available film formers.

It is believed that the use of liquid cyanoacrylate monomers allows for better diffusion through the bulk than solid cyanoacrylate monomers, giving a faster room temperature cure.

When solid thermoplastic polyether polyurethane resins are combined with liquid cyanoacrylate monomers, the resulting films not only have high internal structural integrity but also cure immediately on contact with standard substrates.

Solid thermoplastic polyether polyurethane resins suitable for use in the invention are those having a molecular weight Mw in the range of from about 180,000 g/mol to about 260,000 g/mol. Suitably, the solid thermoplastic polyether polyurethane resin has a molecular weight Mw in the range of from about 200,000 g/mol to about 240,000 g/mol, such as about 215,000 g/mol to 230,000 g/mol for example 220,000 g/mol to 225,000 g/mol for example about 223,000 g/mol, wherein the molecular weight Mw is as determined in accordance with ASTM D5296-05. The solid thermoplastic polyether polyurethane resin may have a melting point from 160° C. to 200° C. such as from 165° C. to 190° C. for example from 170° C. to 180° C. Suitable solid thermoplastic polyether polyurethane resins include Pearlbond® 960, available from Lubrizol, Carrer del Gran Vial, 17, 08160 Montmelo, Barcelona, Spain. Pearlbond® 960 is a solid thermoplastic polyether polyurethane resin having a Mw of 222,906 as determined in accordance with D5296-05 (Standard Test Method for Molecular Weight Averages and Molecular Weight Distribution of Polystyrene by High Performance Size-Exclusion Chromatography) and having a melting point over the range of 170° C. to 180° C.

Formulation of the compositions and products of the present invention can be achieved by combining a solid thermoplastic polyether polyurethane resin with a solvent and stirring at elevated temperatures. Desirably, the mixture is stirred at an elevated temperature, for example at about 65° C. The actual temperature used may vary depending on the melting point of the TPU used or its solubility. Mixing is performed for a time sufficient to dissolve the TPU component into the solvent, which can vary depending on the batch size. At this stage, a stabiliser may be added. The cyanoacrylate component is then added to the composition. Without wishing to be bound by any theorem, it is believed that the late addition of the cyanoacrylate component has a beneficial effect on the stability of the final product.

The adhesive formulation can be applied to a substrate, such as for example a release liner, optionally by casting. The substrate can be left for a period of time, for example about 5 minutes, optionally at an elevated temperature, such as for example about 60° C., to facilitate removal of the solvent. After this period, the film thickness may be substantially smaller than the wet coating thickness. Once the solvent has evaporated, rapid spooling may be carried out in order to prevent dust particles or moisture from contacting the surface of the film.

Suitably, the compositions of the invention may be provided in any suitable solid form including tape form, filament form or as a coating applied to a substrate including for example a filament or thread made from another material such as a nylon or polyester thread. The composition in its solid form such as tape form, or filament form may have sufficient integrity to be handled without breaking. The composition in its solid form such as tape form or filament form can be applied to substrates, for example metal bolts, at room temperature. The composition in its solid form such as tape form or filament form may be capable of thermal resistance at temperatures of at least 150° C., for example 180° C. This means that the composition is robust enough to maintain performance at the temperatures of common industrial environments. Even at elevated temperatures, the composition in its solid form such as tape form, or filament form may be non-tacky and dry to touch such that a carrier, such as a release liner, is not required. The composition in tape form, or filament may be rolled up onto itself and will not adhere to itself as it is non-tacky and dry to touch. Alternatively the tape form, or filament form may comprise a curable composition as described herein and one or more release liners. For example, when the temperature at which the composition is to be stored is above 40° C. a release liner may be useful as at temperatures above 40° C. the non-tacky composition may become tacky and may adhere to itself. As mentioned above the composition of the invention may also be any suitable solid form including tape form, filament form or as a (solid, dry to touch) coating applied to a substrate including for example a filament or thread made from another material such as a nylon or polyester thread.

### Definitions and Standard Test Methods

As used herein, the term “liquid” means in a liquid state within the temperature range of from about 5° C. to 30° C., suitably in a liquid state at room temperature and at atmospheric pressure.

As used herein, the term “solid” means in a solid state within the temperature range of from about 5° C. to 40° C., suitably in a solid state at room temperature and at atmospheric pressure. Solid state is defined as the state of matter in which materials are not fluid but retain their boundaries without support, the atoms or molecules occupying fixed positions with respect to each other and unable to move freely.

As used herein, the word ‘tape’ refers to an article comprising a curable composition and one or more release liners.

As used herein, the phrase ‘stabiliser’, or ‘Lewis acid stabiliser’ refers to a substance that stabilises the curable cyanoacrylate component, for example by inhibiting premature polymerisation of the cyanoacrylate. Examples of such substances include boron trifluoride (BF₃) or sulfur dioxide (SO₂). The skilled person will readily appreciate that other suitable stabilisers, for example another suitable Lewis acid, could be used to stabilise the curable cyanoacrylate component. It is disclosed that stabiliser solutions can be prepared using ethyl cyanoacrylate, β-methoxy cyanoacrylate, or butyl cyanoacrylate as the carrier for the stabiliser, said stabiliser solutions being suitable for adjusting the amount of stabiliser in curable compositions based on ethyl cyanoacrylate, β-methoxy cyanoacrylate, or butyl cyanoacrylate respectively.

In respect of the present invention tack free means dry to the touch yet the composition will not flake off during handling or use. For example an article to which the composition of the invention is applied is dry to the touch. An article to which a composition of the invention has been applied is considered dry to the touch if 20 of such articles are individually placed on dry tissue paper for four hours and there is no change in appearance of the tissue.

Molecular weights disclosed herein are determined in accordance with ISO 13885-1:2008, “Binders for paints and varnishes—Gel permeation chromatography (GPC)—Part 1: Tetrahydrofuran (THF) as eluent”.

Melting and re-solidification temperature ranges were measured in accordance with ISO 1137-1:2016 “Plastics—Differential scanning calorimetry (DSC)—Part 1 General Principles”.

### EXAMPLES

Example compositions of the invention may be those provided in Table 1.

TABLE 1

| | Weight/g | | |
|---|---|---|---|
| Component | Example 1 | Example 2 | Example 3 |
| Pearlbond 960 polyether- | 300 | 300 | 300 |
| based thermoplastic | | | |
| polyurethane | | | |
| Ethyl acetate | 300 | 300 | 250 |
| Butyl cyanoacrylate | 162 | — | — |
| β-methoxy cyanoacrylate | — | 162 | 60.8 |
| Boron trifluoride (1000 ppm | 5.0 | 5.0 | 14.2 |
| solution in ethyl | | | |
| cyanoacrylate) | | | |

The compositions of Table 1 may be prepared as follows:

The solid thermoplastic polyether polyurethane resin is dissolved in a solvent, such as ethyl acetate, in a suitable vessel. The mixture is brought to a suitable temperature, for example about 65° C., and stirred until full dissolution of the solid thermoplastic polyether polyurethane resin is achieved. A stabiliser is then added, followed by the relevant cyanoacrylate monomer.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A curable composition comprising:
a cyanoacrylate component; and
a solid thermoplastic polyether polyurethane resin; and
wherein the solid thermoplastic polyether polyurethane resin has a molecular weight Mw in the range of from about 180,000 g/mol to about 260,000 g/mol, wherein the molecular weight Mw is as determined in accordance with ASTM D5296-05.

2. A composition according to claim 1, wherein the solid thermoplastic polyether polyurethane resin has a molecular weight Mw in the range of from about 200,000 g/mol to about 240,000 g/mol, wherein the molecular weight Mw is as determined in accordance with ASTM D5296-05.

3. A composition according to claim 1, wherein the solid thermoplastic polyether polyurethane resin has a melting point from 160° C. to 200° C.

4. A composition according to claim 1, wherein the cyanoacrylate component is a liquid curable cyanoacrylate component.

5. A composition according to claim 1, wherein the cyanoacrylate component is selected from the group comprising ethyl cyanoacrylate, butyl cyanoacrylate, β-methoxy cyanoacrylate, and combinations thereof.

6. A composition according to claim 1, wherein the solid thermoplastic polyether polyurethane resin is present in an amount of from about 25 wt % to about 90 wt %, based on the total weight of the composition.

7. A composition according to claim 1, wherein the cyanoacrylate component is present in an amount of from about 10 wt % to about 75 wt %, based on the total weight of the composition.

8. A composition according to claim 1, further comprising from about 5 ppm to about 200 ppm of a stabiliser of the cyanoacrylate component.

9. A composition according to claim 8, wherein the stabiliser is selected from boron trifluoride (BF₃) or sulfur dioxide (SO₂).

10. A composition according to claim 9, wherein the stabiliser is sulfur dioxide (SO₂).

11. A composition according to claim 1, further comprising a solvent selected from the group comprising ethyl acetate, tetrahydrofuran, methyl ethyl ketone, cyclohexanone, and acetone.

12. A composition according to claim 11, wherein the solvent used is ethyl acetate.

13. A composition according to claim 1 provided in tape form, filament form or in the form of a coated substrate.

14. A composition according to claim 1 provided in tape form.

15. A tape comprising a curable composition according to claim 1 and one or more release liners.

16. A method of preparing a curable composition comprising the steps of:
i) combining a solid thermoplastic polyether polyurethane resin component as set out in claim 1 with a cyanoacrylate component as set out in any of claims 1 to 12 and a solvent to form a mixture;
ii) applying the mixture of step (i) to a substrate, optionally by casting;
iii) allowing the solvent to evaporate or actively removing the solvent, thereby forming a solid form curable composition.

17. A method according to claim 16 wherein the substrate is a release liner.

18. A method according to claim 16, wherein the solvent is ethyl acetate.

19. A method according to claim 16, wherein said solid thermoplastic polyether polyurethane resin is present in the curable composition in an amount of greater than about 50 wt %, wherein the weight percentage is based on the total weight of the composition.

20. A composition according to claim 1 in cured form.

21. An assembly comprising two substrates bonded together by the cured form of the composition according to claim 1.
